(19) United States
(12) Patent Application Publication
(10) Pub. No.: US 2010/0022287 A1
(43) Pub. Date: Jan. 28, 2010

(54) DANCE GAME MACHINE, METHOD FOR SCORING DANCE GAME AND COMPUTER-READABLE RECORDING MEDIUM

(75) Inventor: Hiroyuki Chiwata, Honolulu, HI (US)

Correspondence Address: BAKER & MCKENZIE LLP;PATENT DEPARTMENT, 2001 ROSS AVENUE, SUITE 2300, DALLAS, TX, 75201, US

(73) Assignee: KONAMI DIGITAL ENTERTAINMENT, CO., LTD., Tokyo (JP)

(21) Appl. No.: 12/569,285

(22) Filed: Sep. 29, 2009

Related U.S. Application Data
(62) Division of application No. 11/239,633, filed on Sep. 29, 2005.

(51) Int. Cl. A63F 9/24; A63F 13/00

(52) U.S. Cl. 463/7; 463/37; 463/35

(57) ABSTRACT

A dance game machine has a mode wherein instruction information to guide a player's dance motion is displayed on a display part, and a mode wherein the instruction information is not displayed. If not displayed, a storage part stores music data, step data, screen data, and comment data corresponding to the mode. A control part reproduces the stored music data sequentially, as well as outputting to the display part the screen data corresponding to the music data, but excepting the instruction information. An input receiving part receives operational input data based on a player's dance motion, while reproducing the music data sequentially. A determination part creates evaluation data of the player's dance motion by comparing dance data being created based on the music data and the step data with operational input data of the player, and outputs the evaluation data to the control part. The control part outputs comment data corresponding to the evaluation data to the display part.

### RELATED APPLICATION

This application is a Divisional application of U.S. patent application Ser. No. 11/239,633, entitled “Dance Game Machine, Method for Scoring Dance Game and Computer-Readable Recording Medium” filed Sep. 29, 2005, which is herein incorporated by reference in its entirety for all purposes.

### TECHNICAL FIELD

This disclosure relates to a method for scoring a dance game capable of being played by a plurality of players.

### BACKGROUND

A dance game in which one can readily and delightfully enjoy dancing has been put into practical use as an arcade game and are being sold as a home-use game machine. At the moment that an arrow object flowing from the bottom of a display screen in time to a dance music number is overlapped with a step zone at the top of the display screen, stepping on (or pressing) a controller button showing a same direction as the arrow enables a player to clear a corresponding stage.

Because various combinational steps are incorporated for every dance music number, the game is configured to be over or reduce the player's score if a player cannot step timely to a dance music number.

For this reason, a BEGINNER MODE wherein a dancer performs a model play (dance) on a screen is included so that even a beginner can easily enjoy playing the dance game.

However, a much more exciting mode for playing a dance game is required in the market, and therefore various play modes are proposed. In such proposals, for example, a difficulty level can be selected from LIGHT, STANDARD, or HEAVY, or a player can select his/her favorite mode from SINGLE, VERSUS, or DOUBLE, depending on the player's skill.

Recently, there has been in the context that requires a play mode with a significantly higher difficulty level. For this reason, a player does not perform a dance play according to an arrow object flowing from the bottom of a display screen in the predetermined order depending on a dance music number, but plays a dance in the player's favorite way in time to a dance music number, whereby the player can enjoy a more creative play with a higher difficulty level.

Furthermore, in the case that a plurality of players play a dance game simultaneously, a music number or an image depending on a dance being performed by each of the players is played or displayed interactively during dancing as well as whether or not each player is getting into the rhythm is evaluated, whereby a further exciting play mode with a higher difficulty level can be provided.

The disclosed principles can realize a dance game that comprises a freestyle dance mode and an interactive evaluation function as more exciting modes in consideration of the above.

### SUMMARY

An exemplary embodiment according to the disclosed principles is a dance game machine comprising a storage part, a control part, an input receiving part, a display part, and a determination part, which has a mode wherein instruction information to guide a player's dance motion is output to the display part and a mode wherein the instruction information is not output to the display part. The dance game machine is characterized in that in the case that the mode wherein the instruction information to guide a player's dance motion is not output to the display part is selected, the storage part stores music data, step data, screen data, and comment data corresponding to the mode; the control part reproduces the stored music data sequentially as well as outputting to the display part the screen data corresponding to the music data but excepting the instruction information to guide a player's dance motion; the input receiving part receives operational input data based on a player's dance motion while reproducing the music data sequentially; the determination part creates evaluation data of the player's dance motion by comparing dance data being created based on the music data and the step data with operational input data of the player and outputs the evaluation data to the control part; and the control part outputs comment data corresponding to the evaluation data to the display part

The dance evaluation data predefines a motion for a predetermined part in a music number reproduced from the music data, and the determination part may create evaluation data for good evaluation in the case that the operational input data based on the player's dance motion are in accord with the definition data.

The dance game machine has a mode selection function for different levels and the selection allows the control part to change the definition data in which a motion for a predetermined part in a music number reproduced from the music data is predefined.

The control part may select the comment data from the storage part based on history information on the player's dance motion for a predetermined time duration and output the comment data to the display part.

The comment data is displayed during an operational input by the player's dance motion, and the control part may further create image information corresponding to the comment data and output the information to the display part.

The dance game machine has a mode wherein multiple sets of operational input data based on a plurality of players' dance motions are received and a mode wherein a set of operational input data based on a single player's dance motion is received, and in the case that the mode wherein a set of operational input data based on a single player's dance motion is received is selected, dance data for virtual players created by the control part may be output to the display part and displayed as a plurality of players' dance motions.

The screen data includes a plurality of character information that can be selected by a plurality of players; the display part displays the character information and the screen data excepting the instruction information to guide a player's dance motion created in the control part; and in the case that operational input data based on a player's dance motion are in accord with the definition data, the control part may output an instruction signal for displaying a magnified character selected by the player to the display part.

The screen data includes history information on a plurality of players' dance motions; the history information and the screen data excepting the instruction information to guide a player's dance motion created in the control part are input to the display part; and in the case that operational input data based on a player's dance motion are in accord with the definition data, the control part may output an instruction signal for displaying the player's history information with decoration.

In the case that the mode wherein multiple sets of operational input data based on a plurality of players' dance motions are received is selected, the determination part may create evaluation data for bad evaluation if during a predetermined time duration, the multiple sets of operational input data by the plurality of players are created at the same time and inputs with same direction are implemented with a predetermined probability

The screen data includes a plurality of character information that can be selected by a plurality of players or history information; the evaluation data are displayed after operational inputs by the players' dance motions are complete; and the control part may select one character corresponding to one player among the plurality of players depending on the evaluation data and output information to the display as if the character introduces a comment or history information.

Another embodiment according to the disclosed principles is a method for scoring a dance game having a freestyle mode wherein instruction information to guide a dance motion in advance is not displayed. The method comprises: comparing input data based on a dance motion performed by a player in response to the reproduction of a music number with predefined score data and then scoring the dance performed by the player; and creating screen data and music data based on the score and then displaying the screen data and the music data during the player's play.

The screen data includes a plurality of character information that can be selected by a plurality of players or history information; and in the case that operational input data based on a dance motion performed by one player among the plurality of players are in accord with predefined definition data, screen data for displaying a magnified character selected by the player are created and displayed during the player's play.

The screen data includes a plurality of character information that can be selected by a plurality of players or history information; the screen data based on scores are displayed even after operational inputs by the players' dance motions are complete; one character corresponding to one player among the plurality of players is selected depending on the screen data; and information may be created as if the character introduces a comment or history information.

Still another embodiment according to the disclosed principles may be a computer-readable recording medium onto which a program for detecting data input through a dance pad in response to a music number reproduced by a reproducing apparatus and for implementing a procedure with which a determination part creates evaluation data, by using a computer provided to a dance game machine comprising: the reproducing apparatus for reproducing predetermined music numbers; the dance pad for inputting a player's dance motion; a display part for receiving image information corresponding to the predetermined music numbers; and a control part for creating evaluation data and comment data for the player's dance motion, is recorded. The computer-readable recording medium stores the program that comprises the steps of: in the case of that a mode in which instruction information to guide a dance motion in advance is not displayed is selected, predefining a motion for a predetermined part in a music number to be reproduced by the reproducing apparatus, and then in the case that operational input data based on a player's dance motion are in accord with the predefined data, creating data for good evaluation; creating predetermined comment data; and creating image data corresponding to the comment data and then outputting the image data to the display part.

The computer-readable recording medium may include a plurality of character information that can be selected by a plurality of players; and may store the program comprising the steps of, in the case that input data by one player among a plurality of players are in accord with the predefined definition data, creating screen data for displaying a magnified character selected by the player; and displaying the screen data during the player's play.

The computer-readable recording medium may include a plurality of character information that can be selected by a plurality of players or history information, and may store the program comprising the steps of: creating information to display screen data based on scores even after operational inputs by the players' dance motions are complete; creating information to select one character corresponding to one player among the plurality of players depending on the screen data; and creating information as if the character introduces a comment or history information.

Employing the means to solve the problem described above enables the realization of a dance game with higher difficulty.

### BRIEF DESCRIPTION OF DRAWINGS

FIG. 1 is a diagram illustrating a configuration of a dance game machine according to an embodiment according to the disclosed principles.

FIG. 2 illustrates a display screen during dancing in a freestyle mode wherein the instruction information to guide a dance motion in advance is not displayed, according to an exemplary embodiment.

FIG. 3 illustrates a display screen during dancing in a normal mode wherein a dance motion is guided in advance, according to an exemplary embodiment.

FIG. 4 illustrates a screen on which selected characters are centrally displayed, according to an exemplary embodiment.

FIG. 5 shows a display screen illustrating comment data that are displayed during dancing, according to an exemplary embodiment.

FIG. 6 shows one embodiment of a display screen illustrating history information that is displayed during dancing.

FIG. 7 illustrates a screen on which a magnified character and history information are displayed, according to an exemplary embodiment.

FIG. 8 shows a screen displaying scores after dancing is complete, according to an exemplary embodiment.

FIG. 9 shows a screen on which a character's comment is displayed after dancing is complete, according to an exemplary embodiment.

FIG. 10 is a table showing one embodiment of analysis information used for evaluation.

FIG. 11 is a table describing various exemplary comment types and corresponding processes for generating them.

FIG. 12 is a process flow chart in the dance game machine according to an exemplary embodiment.

FIG. 13 is an evaluation process flow chart in the dance game machine according to an exemplary embodiment.

FIG. 14 is a flow chart for comment creation process in the dance game machine according to an exemplary embodiment.

FIG. 15 is a diagram illustrating a configuration of a storage part 3, according to an exemplary embodiment.

FIG. 16 is a diagram illustrating an exterior configuration of a home-use dance game comprising the dance game machine according to an exemplary embodiment.

FIG. 17 is a diagram illustrating an exterior configuration of a dance game for business use comprising the dance game machine according to an exemplary embodiment.

### DETAILED DESCRIPTION

To accomplish the above objects, exemplary embodiments are disclosed below in accordance with the disclosed principles.

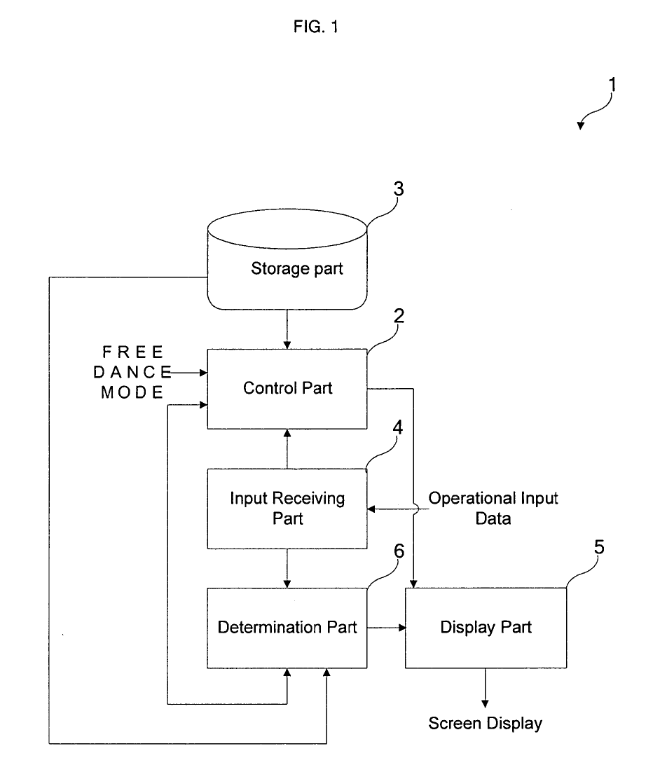

FIG. 1 is a diagram illustrating a configuration of a dance game machine 1. The dance game machine 1 comprises a control part 2, a storage part 3, an input receiving part 4, a display part 5, and a determination part 6, and is configured as followed.

The control part 2 receives a free dance mode signal, followed by reading screen data other than the instruction information to guide a dance motion for a player from the storage part 3 and then outputting the data to the display part 5. Also, the control part 2 sequentially reads a voice data string stored in the storage part 3 and then reproduces it. In other words, after the voice data string is sequentially (typically from the top of the string) read from the storage part and then decompressed if compressed or interpreted as commands, waveform data are obtained, which are then output from speakers or the like. The reproduced voice waveform provides a dance music number for a player in the game.

The control part 2 further reads comment data from the storage part 3 based on data input from the determination part 6 and outputs the comment data to the display part 5. Also the control part 2 reads step data from the storage part 3 in response to a request from the determination part 6 and then outputs the data to the determination part 6.

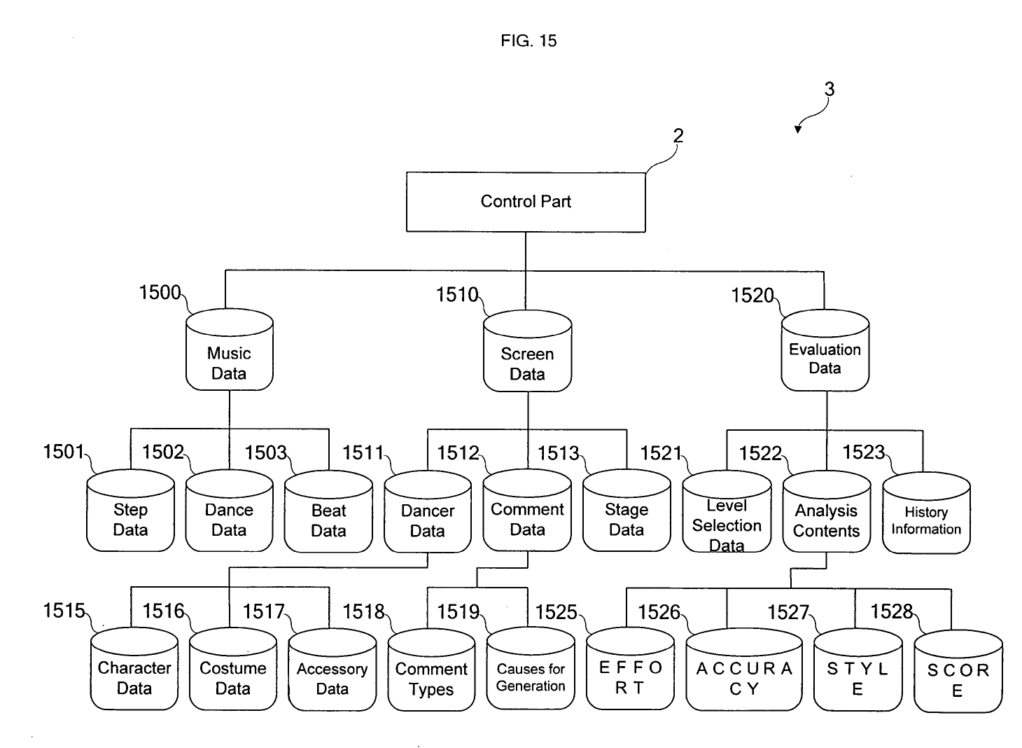

The storage part 3 stores music data, step data, image data and comment data. The music data are typically in the form of a voice data string, such as in the PCM (Pulse Code Modulation) format, MP3 (MPEG Audio Layer-3) format or Ogg Vorbis format, which is a series of data transformed from voice waveform so that a computer can process. Also commands for issuing play instructions to electronic music instruments, such as in the MIDI (Musical Instrument Digital Interface) format, may be used for the voice data string. A specific configuration of the storage part 3 will be described in reference to FIG. 15.

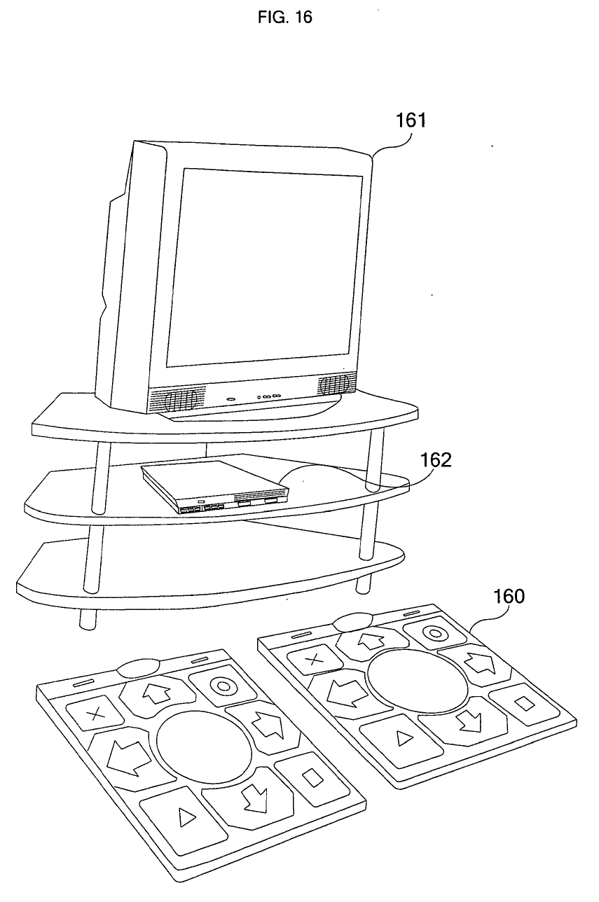

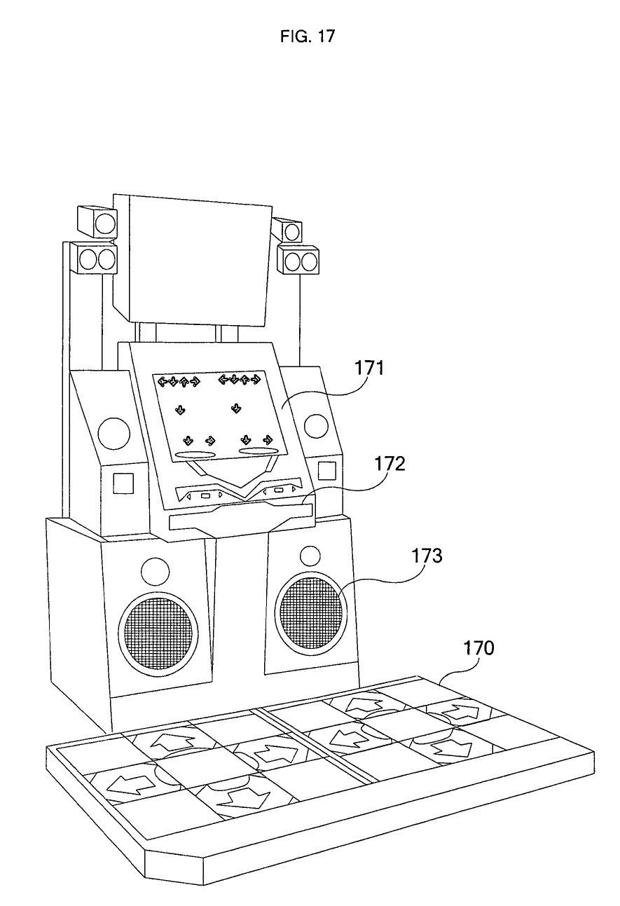

The input receiving part 4 receives an operational input during the sequential reproduction of the voice data string. The input receiving part 4 is connected to a dance pad 160 shown in FIG. 16 or 170 in FIG. 17. According to the disclosed principles, the input receiving part 4 may be connected to a typical game controller used for a home-use game machine.

The display part 5 receives information from either the control part 2 or the determination part 6 and then outputs the information to a display device. The display part 5 is connected to either a television set 161 shown in FIG. 16 or a display device 171 shown in FIG. 17.

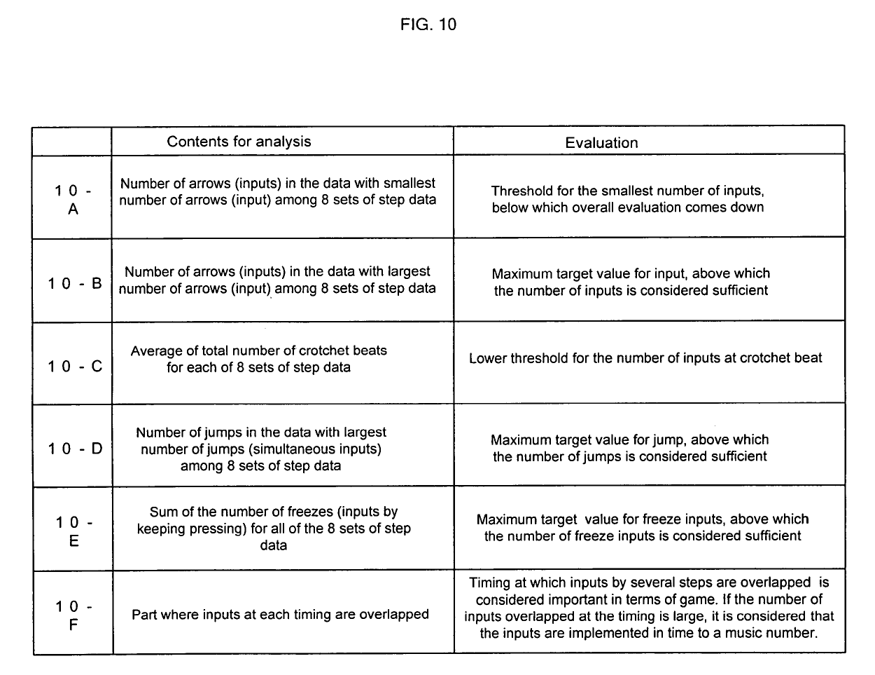

The determination part 6 compares a dance data created based on both the music data and step data with operational input data input by a player through the input receiving part 4, and then creates evaluation data for the player's dance motion. The evaluation data are output to the control part 2 or the display part 5 by the determination part 6. The music data and the step data are available by accessing information stored in the storage part 3 through the control part 2. The process for creating the evaluation data will be described in reference to FIG. 10.

Next, the operation of the dance game machine 1 will be described. When the control part 2 receives a “FREE DANCE MODE” signal, it reproduces the music data sequentially from the storage part 3 as well as outputting to the display part 5 the screen data corresponding to the music data, but excepting the instruction information for guiding a player's dance motion.

The input receiving part 4 receives the operational input data by the dance motion performed in a player's favorite way to a dance music number by the player during reproducing the music data sequentially and then outputs the operational input data to either the control part 2 or the determination part 6.

The determination part 6 retrieves the music data and the step data from the storage part 2 directly or through the control part 2, and then creates dance data for evaluation based on both the music data and the step data followed by the comparison of the dance data with the operational input data input by the player. This enables the determination part 6 to create evaluation data for the player's dance motion and then to output the evaluation data to either the control part 2 or the display part 5.

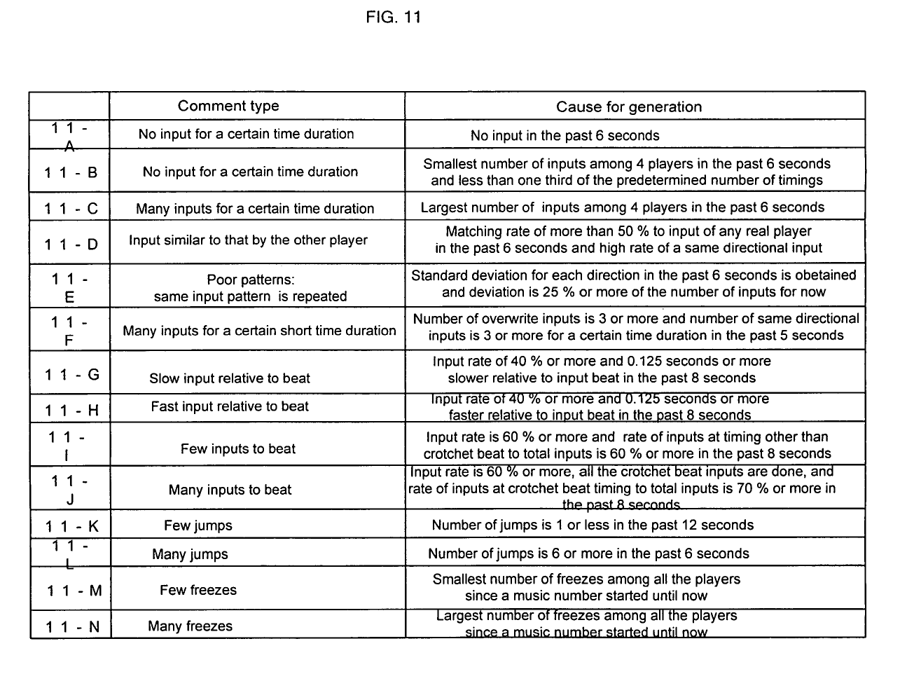

The control part 2, then, creates comment data corresponding to the evaluation data based on information in the storage part 2 and output the comment data to the display part 5. The process for creating the comment data will be described in reference to FIG. 11.

Configuring as described above enables the player to enjoy the FREE DANCE MODE wherein the player can dance in the player's favorite way in time to a dance music number, instead of performing a dance play according to an arrow object flowing from the bottom of a display screen in the predetermined order depending on a dance number.

Furthermore, displaying, during dancing or after dancing, an evaluation or a comment on the dance performed by the player allows the player to enjoy more creative and various plays. In other words, without displaying any instruction information in terms of game, player can perform an operational input desirably, of which the evaluation is displayed or output as a screen image or voice instead. That is, a scoring function found in karaoke is realized in a dance game.

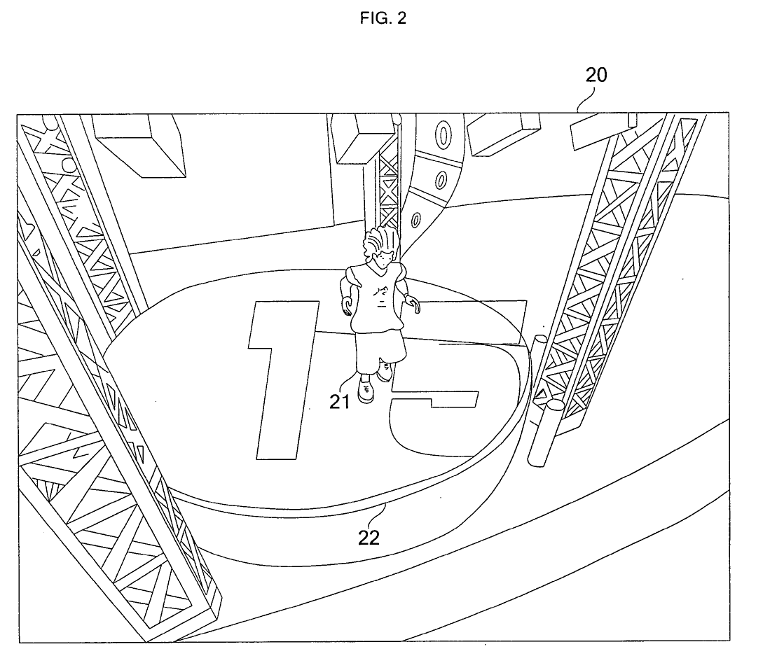

FIG. 2 illustrates a display screen during dancing in a freestyle mode wherein the instruction information to guide a dance motion in advance is not displayed. On the display screen 20 during dancing in a freestyle mode, a dancer 21 representing a player and a stage 22 for dancing are displayed.

Display data for the dancer 21 are created in the control part 2 based on the dance input that is subject to the dance performed desirably to a dance music number by the player, and output to the display part 5.

A player may select the dancer 21 in the game as well as selecting the dancer's gender, height, costume, and accessory. In addition, the selection information stored in the storage part 3, which will be described in reference to FIG. 15, can be accessed and selected by the control part 2, based on information input to the input receiving part 4. Similarly, the player can also select various stages for the display screen 20. In this embodiment, the display content that shows, not exclusively, a young male dancer dancing on a 3D stage in the spotlight is selected.

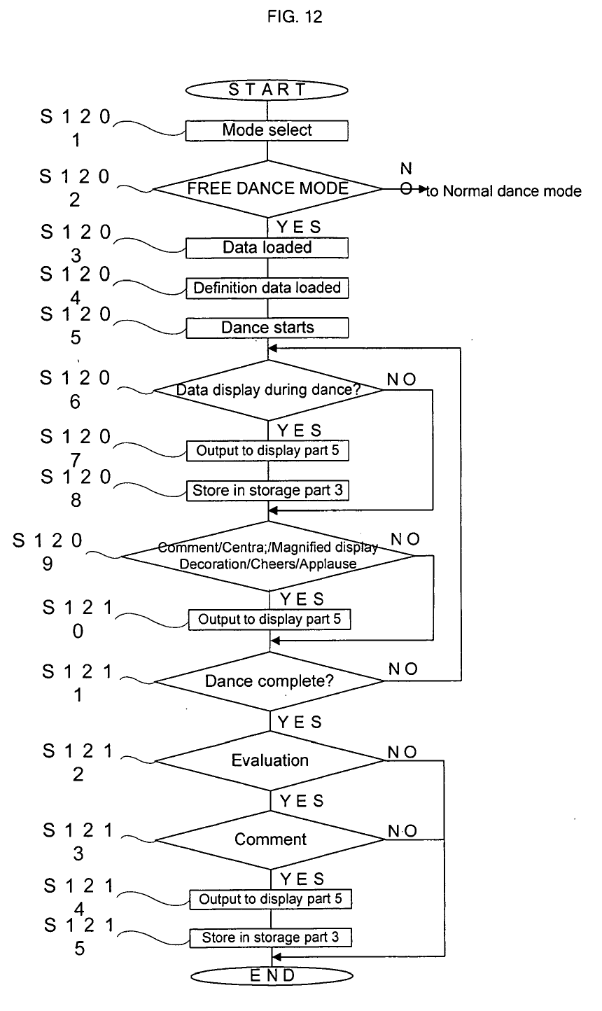

Furthermore, depending on the evaluation of the player's operational input or on a musical beat, screen decorations including particles and/or a remaining time (15 seconds in this embodiment) are displayed. In addition to the decorations, the game is configured to generate cheers and applause based on the evaluation of the player's operational input. These functions become enabled when the control part 2 accesses to the storage part 3 based on information of the determination part 6. The details will be described in reference to FIG. 12.

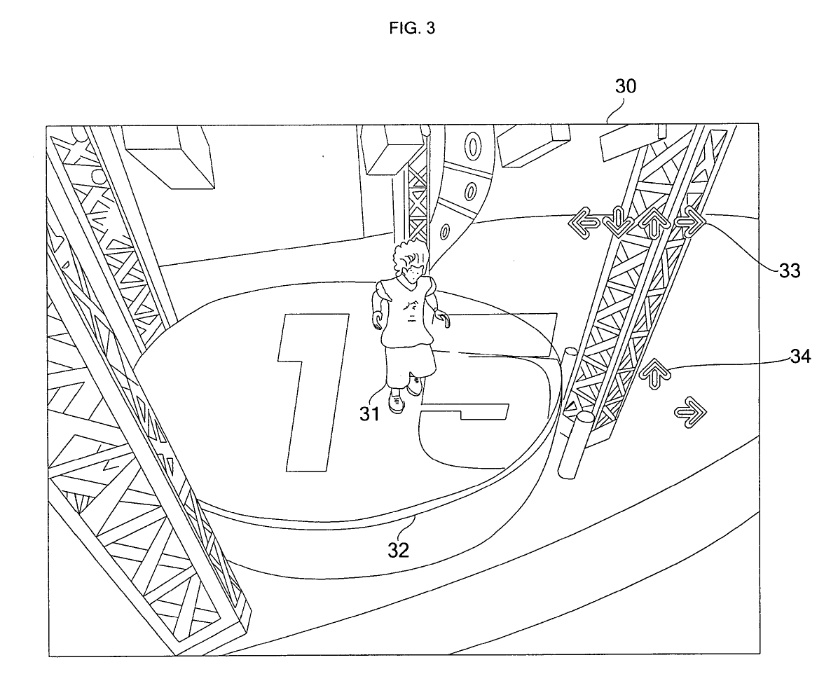

FIG. 3 illustrates a display screen during dancing in a normal mode wherein a dance motion is guided in advance. The diagram shows the case where the control part 2 does not receive the FREE DANCE MODE signal. On the display screen during dancing in the normal mode, a dancer 31 representing a player and a stage 32 for dancing are displayed.

Furthermore, on the display screen in the normal mode, a step zone is displayed and apart from the zone, an arrow object 34 flowing from the bottom of the screen during dancing is displayed. On the instruction of the arrow object 34, the player steps on a step button in the dance pad 160 in FIG. 16 or 170 in FIG. 17, indicating the same direction as the arrow, at the moment that the arrow object 34 overlaps with the step zone 33. This results in timely stepping on the step button.

In the FREE DANCE MODE according to the disclosed principles, both the step zone 33 and the arrow object 34 are not displayed at all, and a player does not perform a dance play in response to music data in the predetermined order in accordance with an arrow object flowing from the bottom of a display screen, but dances in the player's favorite way in time to a dance music number.

This enables a player to enjoy a more creative and difficult play.

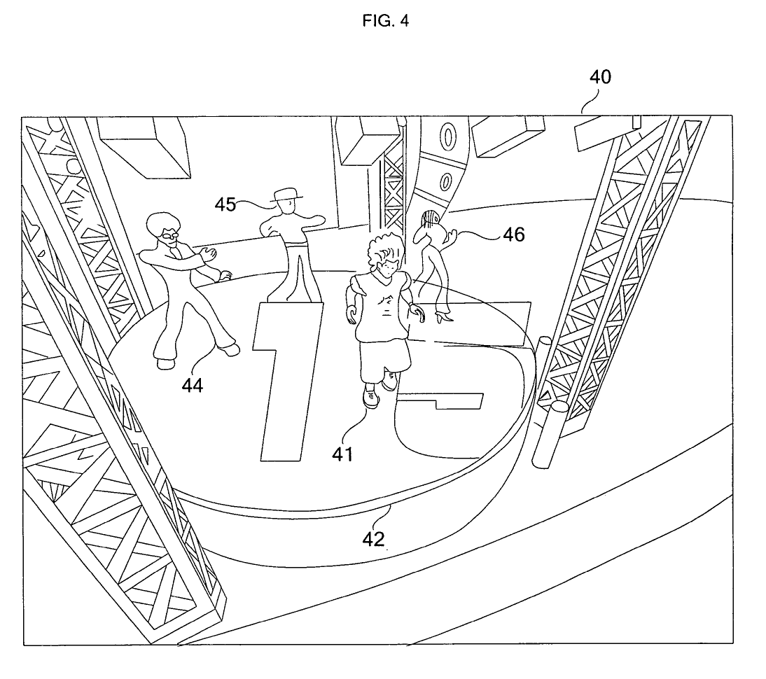

FIG. 4 illustrates a screen on which selected characters are centrally displayed. The dance game machine 1 comprises a mode for receiving multiple sets of operational input data based on the dance motions performed by a plurality of players and a mode for receiving a set of operational input data based on the dance motion performed by a single player.

In the case of selecting the mode for receiving multiple sets of operational input data based on the dance motions performed by a plurality of players, besides one dancer representing one player, the other dancers 44, 45 and 46 representing the other players are also displayed on the display screen 40.

The dancer 41 getting into a music number best among all the dancers is centrally displayed. In addition to the central display, the game machine may be configured to display decorations around the dancer 41 on the display screen 40 and/or to generate cheers and applause.

The determination if the dancer 41 is getting into a music number best is made by the control part 2 using a critical point whether or not operational input data based on the player's dance motion are in accord with predetermined definition data. Then, the control part 2 outputs to the display device 5 an instruction signal for magnifying and displaying the character whose dance input data are in accord with the definition data. The definition data are provided based on an analysis result to be described in reference to FIG. 10.

Alternatively, in the case that the number of inputs implemented at a critical timing during playing a music number is large, the determination part 6 may determine a dancer as getting into the music number best and output a signal for magnifying and displaying the dancer to the display part 5.

Furthermore, the determination part 6 may analyze the content of a music data file, whereby it may detect the critical timing during runtime. For example, the storage part 3 is configured to comprise only music files, but not to comprise the definition data as described above. Then, based on the frequencies, waveforms, volumes, and the like of a drum and a bass in the music files, the determination part 6 determines the critical timing during playing a music number and evaluates a player's dance input.

On the other hand, in the case of selecting the mode for receiving a set of operational input data based on the dance motion performed by a single player, sets of dance data for virtual players created in the control part 2 are output, which are then displayed on the display screen as the sets of dance motions of a plurality of players. In other words, characters other than a character representing a player are all virtual players. Accordingly, the player competes with a computer for dance performance.

Alternatively, a game connected to the Internet may be configured for a player to compete with the other player having a game connected to the Internet. Configuring like this enables a more interactive dance game.

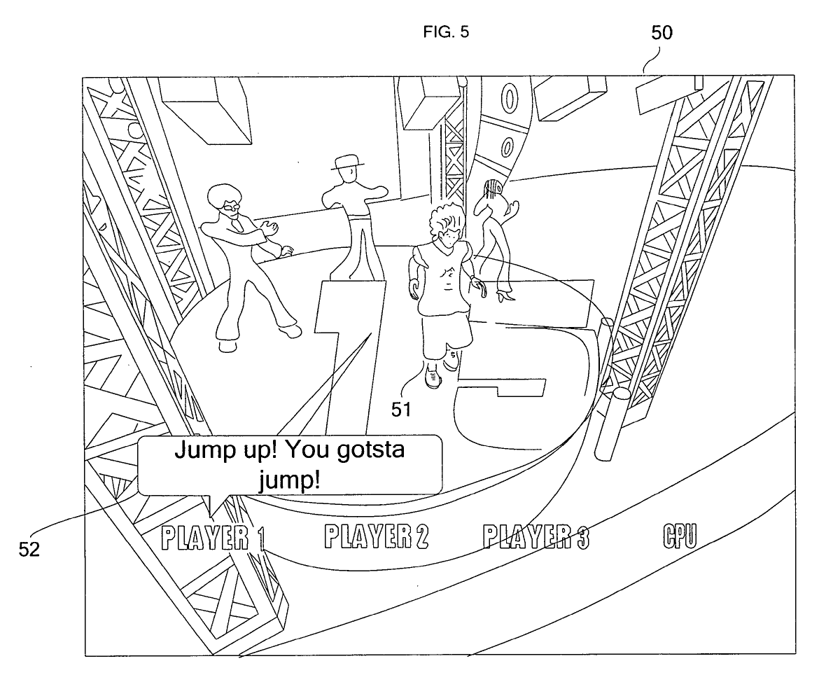

FIG. 5 shows a display screen illustrating comment data that are displayed during dancing. For the dancer getting into a music number best as shown in FIG. 4, various comments are displayed during dancing. On a display screen 50 for displaying the comment data during dancing, a comment such as “Jump up! You gotsta jump!” is displayed for a dancer 51 who is getting into a music number best.

Specifically, in the case that operational input data based on a player's dance motion are in accord with predetermined definition data, the control part 2 outputs to the display device 5 an instruction signal to give a comment to the player, resulting in the display of the comment 52. The definition data are provided based on types as will be described in reference to FIG. 11.

Alternatively, in the case that the number of inputs implemented at a critical timing during playing a music number is large, the determination part 6 may determine a dancer as getting into the music number best and output a signal for displaying a comment to the display part 5 as described above in reference to FIG. 4.

Furthermore, the determination part 6 may analyze the content of a music data file, whereby it may detect the critical timing during runtime and then display a comment.

Also, based on the comment data displayed during the operational input by a player's dance motion, the control part 2 may create image information and then output it to the display part 5. For example, in response to the display of the comment 52 of “Jump up! You gotsta jump!” as described above, a game machine may be configured for a dancer 51 representing a player to actually jump, and then it may also be configured to display a comment, such as “Greeeeaaaat!!!” for the player's operational input in response to the previous comment, to decorate a background and to generate cheers and applause.

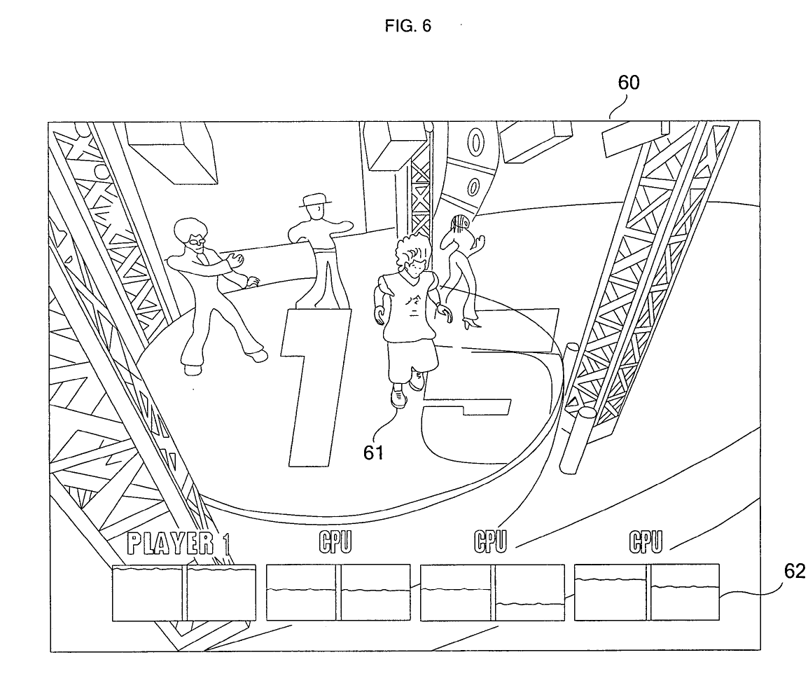

FIG. 6 shows a screen illustrating history information displayed during dancing. At the bottom of the display screen 60, the history information 62 is displayed for each dancer. The history information 62 representing dancer's dance motions is displayed as a graph with a playtime as a horizontal axis and a dance motion as a vertical axis.

The history information 62 can be updated if an input is implemented within certain time duration before or after a defined timing. If intermittent inputs are implemented within the certain time duration, the input closest to the timing is selected. Also, the history information is determined by the total numbers of inputs, freezes, jumps, and the like.

The term “freeze” represents the condition that a player has stopped inputting. The determination criterion for the freeze is that the continuation of an operational input signal for about 0.6 seconds or more is considered as freeze. In other words, keeping pressing a dance pad or an operation button for about 0.6 seconds or more is considered as freeze, and at the moment of releasing the pad or the button, a count is upped.

Also in the determination process for jump, if two operational input signals are input at the completely same time or within 0.08 seconds, “simultaneous inputs=jump” is recognized. Inputting three or more operational input signals simultaneously is considered as an illegal input and is ignored.

Within the certain time duration from input timing for each operational input signal, histories of items such as the number of input overwrites (in case of successive inputs, the number of the inputs are added), entry history (in case of successive inputs, the contents of the inputs are saved), the best entry, the smallest difference from the timing and the like are obtained and displayed as the history information 62.

For example, in the case of many freezes, the graph in the history information shows a downward curve whereas it shows the increase when a jump datum is input. In this way, a player's dance motion is dynamically displayed. Also, the history information is stored in the storage part 2 and utilized as a criterion for a final evaluation.

Furthermore, the control part 2 outputs an instruction signal for displaying player's history information with decoration to the display part 5 when operational input data based on the player's dance motion are in accord with predetermined definition data.

For example, when a player continues to jump to a music number, a comment such as “Goooooooood Jooooooooooob!!!” is displayed in addition to displaying the history information of the player with decoration.

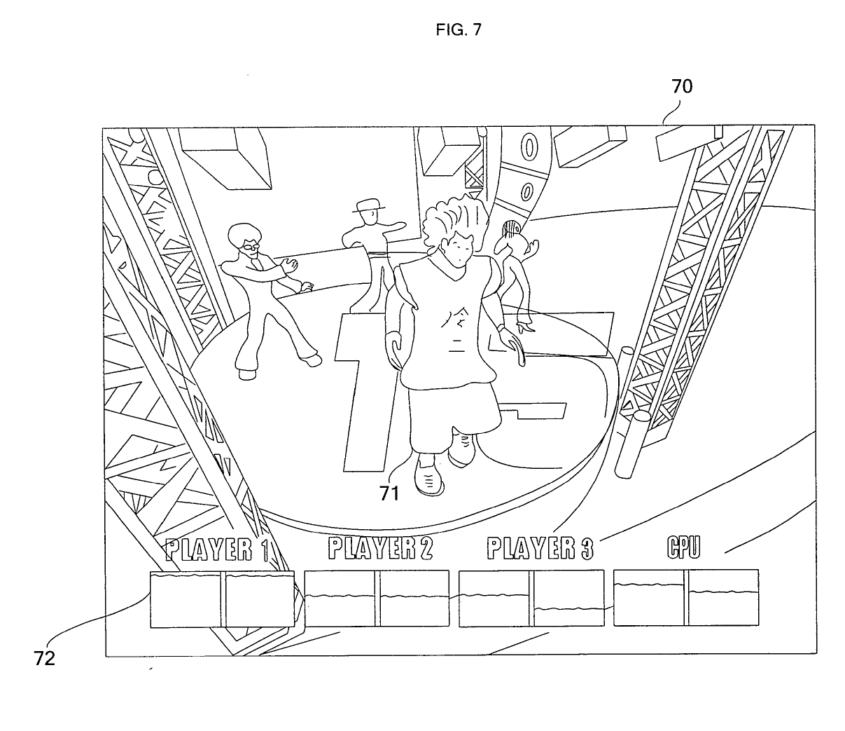

FIG. 7 illustrates a screen on which a magnified character and history information are displayed. On the screen 70 on which a magnified character and history information are displayed, a dancer who is getting into a music number best during dancing is magnified as well as the history information 72 of the dancer is decorated in sparkling rainbow colors. Also, besides the history information 72 decorated, a game machine may be configured to generate cheers and applause.

Furthermore, the control part 2 may select comment data from the storage part 2 based on history information obtained during predetermined time duration for a player's dance motion, and then output the data to the display part 5, whereby a comment based on the player's history information is displayed and an interactive dance game can be realized.

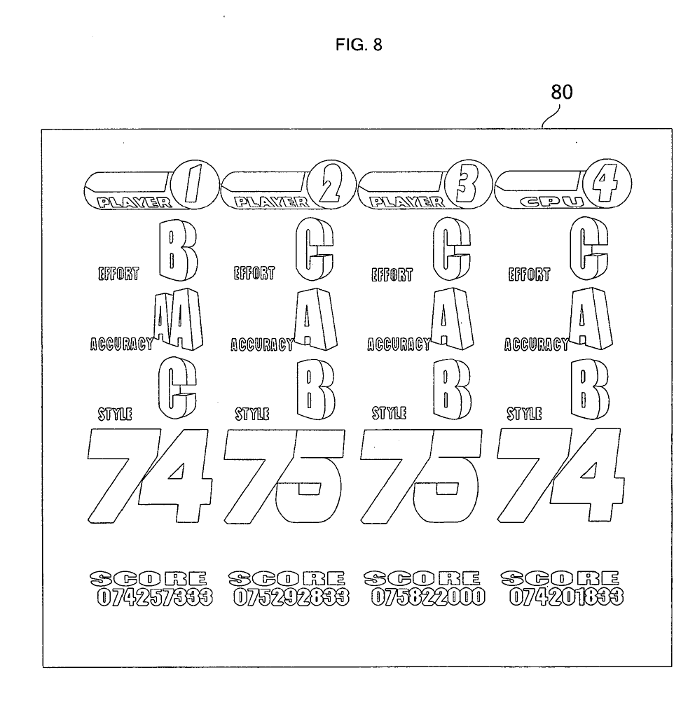

FIG. 8 shows a screen for displaying scores after dancing. At the stage of displaying scores 80 after dancing, the determination part 5 evaluates the EFFORT, ACCURACY and STYLE for each player and outputs to the display part 5. The evaluation results may be displayed as “AAA” to “E” or on a 100-point scale.

The evaluation of EFFORT is simply, but not exclusively, calculated based on the number of inputs. The evaluation of ACCURACY is calculated based on the average difference from the input timing and in the case of extremely small number of inputs, the number of inputs is set to a coefficient of 1 or less. The evaluation of STYLE is determined based on the ratio of the number of the inputs to the overlapped step part to the total number of inputs. For example, the evaluation of STYLE is calculated based on the numbers of illegal inputs, jumps, and freezes, and the standard deviation of each key input.

Then, based on the above information, the determination part 6 calculates scores. The disclosed principles enable the scores to be displayed, not exclusively, on a 100-point scale to a 100,000,000-point scale.

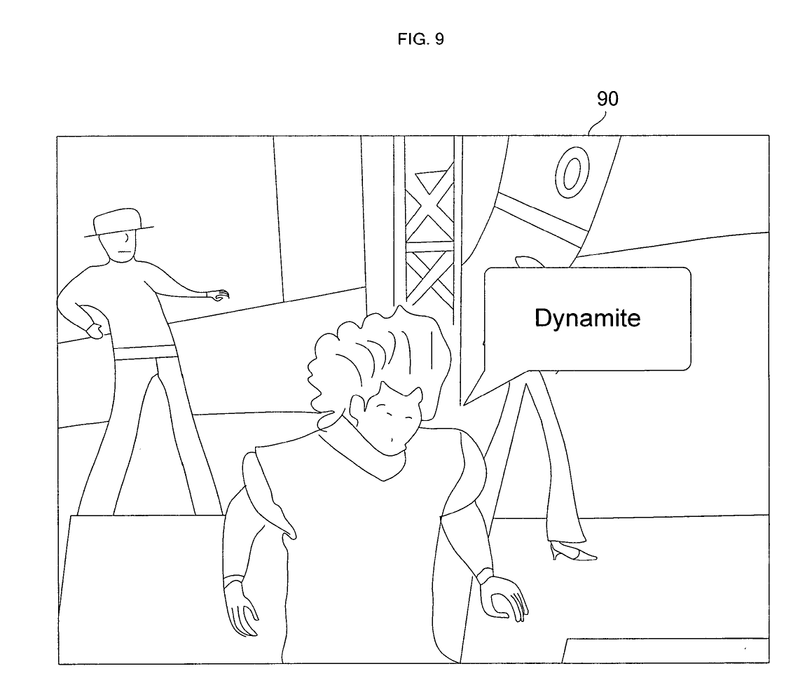

FIG. 9 shows a screen on which a character's comment is displayed after dancing. On the screen 90 displaying a character's comment, a comment is displayed as if a dancer who has got the highest evaluation score gives the comment to a corresponding player.

Specifically, after the completion of the operational inputs by players' dance motions, the control part 2 selects a character representing one player among a plurality of players based on the evaluation for each of the players and outputs corresponding information to the display part 5 as if the character introduces a comment or history information.

FIG. 10 is a table showing analysis information used for evaluation. The analysis information used for evaluation is categorized, not exclusively, into 6 different types, i.e., 10-a to 10-f in the present embodiment. For each type of information, evaluation content is defined. Before a music number is started, 8 different modes (BEGINNER, LIGHT, STANDARD, or HEAVY for single or double) associated with music numbers are analyzed with these types of analysis information, whereby critical points in terms of music and dance game are determined.

The six different contents for analysis are: the number of arrows (inputs) in the data with the smallest number of arrows (inputs) among eight sets of step data (10-a); the number of arrows (inputs) in the data with the largest number of arrows (inputs) among the eight sets of step data (10-b); an average of the total number of crotchet beats for each of the eight sets of step data (10-c); the number of jumps in the data with largest number of jumps (simultaneous input) among the eight sets of step data (10-d); sum of the number of freezes (inputs by keeping pressing) for all of the eight sets of step data (10-e); and a part where inputs at each of input timing are overlapped (10-f), as shown in FIG. 10. For each of the above six analysis contents, evaluation content and a criterion are predefined.

For a part where inputs at each of input timing are overlapped (10-f), if a part input by a plurality of players in consideration of being important in terms of a game has a large number of inputs overlapped, it is considered that the inputs are implemented in time to a music number. This embodiment employs such a determination process; however, the other approach with the above values can create evaluation data.

FIG. 11 is a table describing various comment types and corresponding processes for generating them. This embodiment determines one character that makes a comment, by selecting, not exclusively, among characters operated by players. For equality, the one character may be picked up randomly; however, in the case that a predetermined condition is met, one player may be specified, not randomly. For example, the condition includes no operational input for certain time duration, input information for one player similar to that for the other player, and the like. Such a condition results in bad evaluation as well as the generation of a comment.

Specifically, the determination part 6 is configured to create bad evaluation data in the case that during a predetermined time duration, operational inputs by a plurality of players are implemented at the same time and the inputs with a same direction are implemented with a predetermined probability. Then, based on the evaluation data, the control part 2 accesses the storage part 2 followed by outputting comment data to the display part 5.

Also, at the moment that a comment is displayed, picked-up player's history information in the past about 5 to 12 seconds is analyzed, and then the determination part 2 may determine the content (type) of a comment to be selected. Many comments are stored in the storage part 2, from which a comment can be randomly selected for each type.

FIG. 11 shows comment types and corresponding determination processes. For example, in the case of no operational input information in the past 6 seconds, the control part 2 recognizes that corresponding player's dance motion belongs to a type of no input for a certain time duration, and then a display such as “Let's dance”, “Let's Get Started!” or “Show your Dance!!!” is randomly made. For each type, a plurality of comments are prepared.

FIG. 12 is a process flow chart in the dance game machine 1. Specifically, it is the flow chart describing a process sequence to be used for the implementation of a dance game according to the disclosed principles by the control part 2.

In the present embodiment, after a player turns on a home-use dance game machine shown in FIG. 16 followed by the read of a loaded DVD-ROM, the control part 2 starts the process shown in FIG. 12. Alternatively, for an arcade game machine shown in FIG. 17, a player drops the predetermined number of coins from a coin slot and then the coins are authorized by a coin identification device, which then outputs a game start signal to the control part 2. Upon receipt of the signal, the control part 2 starts the process shown in FIG. 12.

The process shown in FIG. 12 starts with the step of Mode Select (S1201) wherein a player selects a game mode. The game mode can be selected from LIGHT, STANDARD, HEAVY, or the like in terms of difficulty, and from SINGLE, VERSUS, or DOUBLE depending on a player's skill. A player can also select a dancer to dance in the dance game him-/herself, including the dancer's gender, height, costume, and accessory at the Mode Select step.

Also at the Mode Select step, a player may select a FREE DANCE MODE wherein the player can dance to a dance music number in his/her favorite way.

Selecting the FREE DANCE MODE allows the process to proceed to the step S1202 at which the FREE DANCE MODE is implemented. If the FREE DANCE MODE is not selected, the process proceeds to a normal dance mode (not shown).

The FREE DANCE MODE allows a player to select a music number to which a player is going to dance by operating an input device such as a dance pad. In this embodiment, one stage is associated, not exclusively, with one music number.

Selecting a music number allows the process to proceed to the step S1203 at which various types of data (including music data, screen data, and the like) required for the game are loaded from the storage part 3 to a RAM in the control part 2, resulting in the configuration required for the implementation of the game. Then, the control part 2 loads step data from the storage part 3 depending on the selected music data (S1204) and the step data are stored in a RAM in the determination part 6.

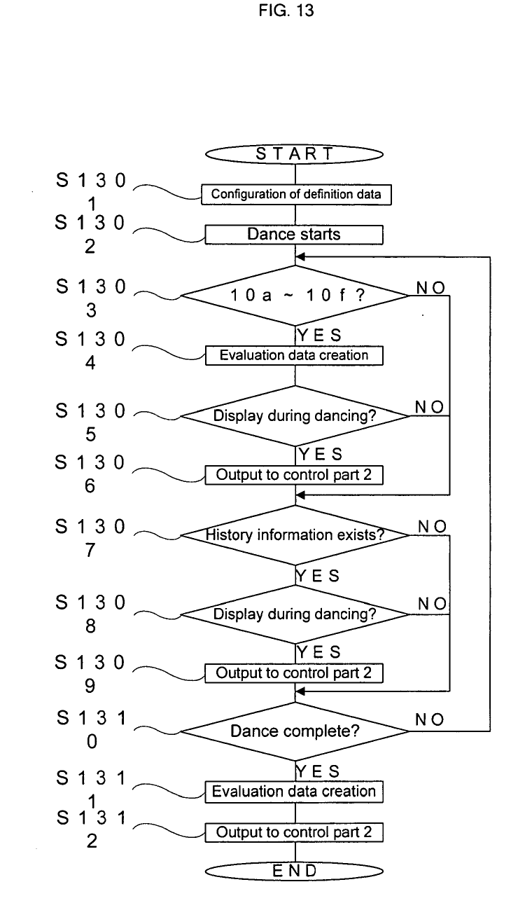

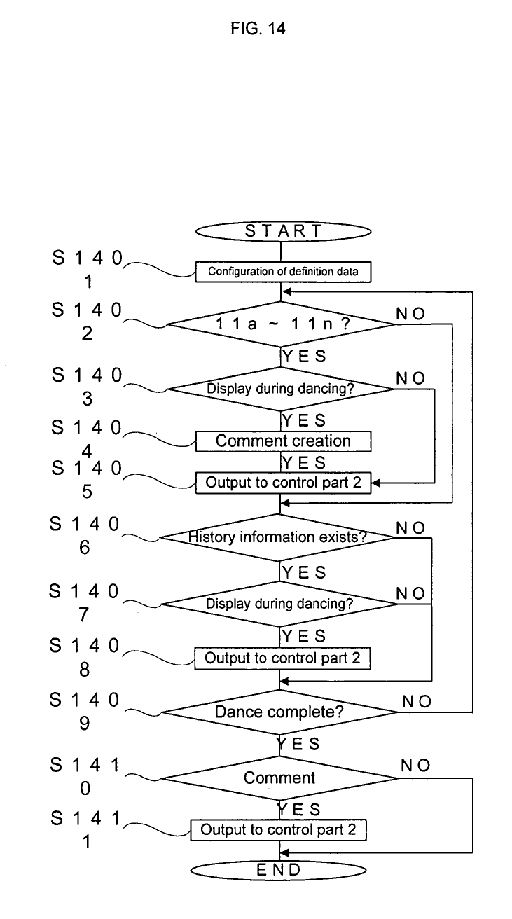

Upon completing this, the process proceeds to the step 1205 at which the play of a selected music number is started. Subsequently, the control part 2 checks whether or not there exists information to be displayed during player's dance motion (S1206). A creation flow for the information to be displayed during dancing will be described in reference to flow charts shown in FIGS. 13 and 14. If there is information to be displayed during dancing, the control part 2 outputs corresponding data to the display part 5 (S1207), which are also stored in the storage part 3 or in the RAM in the control part 2 (S1208). If there is no information to be displayed during dancing, the process skips to the step S1209.

Then, the control part 2 checks the request from the determination part 6 on whether or not there exists a need for a dancer's comment, central display, magnified display, decoration of image information, cheers, or applause. For centrally displaying a dancer, information to be centrally displayed is created based on a request from the determination part 6 in the case of the presence of a dancer who is getting into a dance music number best among dancers during dancing. In addition to the central display, the control part 2 creates information (S1209) upon a request from the determination part 6 so that a decoration can be displayed around the best dancer and/or cheers and applause are generated as has been described with FIG. 4, and then outputs the information to the display part 5 (S1210). In the case of no need for the central display or magnified display of a dancer, decoration of image information, cheers, or applause, the process skips to the step S1211.

Upon completing the music number, the process proceeds to the step S1211 at which the control part 2 waits for the output of evaluation data from the determination part 6 (S1212). If the music number is not yet complete, the process returns back to the step S1206 from which the steps is repeated to the step S1211 until the music number is complete.

After the completion of the music number followed by the receipt of the evaluation data from the determination part 6, the control part 2 creates comment data (S1213), and then outputs and stores display data created based on the comment data and the evaluation data to the display part 5 (S1214) and in the storage part 3 or in the RAM in the control part 2 (S1215), respectively. In addition, the creation of the comment data will be described in reference to FIG. 14. If there is no evaluation data and comment data, the evaluation flow terminates.

The flow as just described above enables scoring process for a dance game wherein scoring a dance performed by a player is implemented by comparing predefined scoring data with input data based on a player's dance motion implemented in response to the reproduction of a music number, and also enables a scoring process for a dance game wherein image data and music data are created based on the score for the dance and displayed during a player's play.

FIG. 13 is an evaluation process flow chart in the dance game machine 1. Specifically, it is the flow chart describing an evaluation procedure to be used for the implementation of a dance game according to the disclosed principles by the determination part 6.

The evaluation process shown in FIG. 13 starts with the step for storing the step data, which was loaded by the control part 2 at the step S1204 in FIG. 12, as definition data in the RAM in the determination part 6 (S1301). The determination part 6 outputs a signal of the completion of definition data configuration to the control part 2, whereby dancing is started (S1302).

Then, the determination part 6 checks using an input signal from the input receiving part 4 whether or not a dance input implemented by a player corresponds to any of the analysis contents, 10-a to 10-f, described in FIG. 10 (S1303).

If the input corresponds to any of 10-a to 10-f, evaluation data are created with the evaluation contents described in FIG. 10 (S1304) and whether or not the evaluation data are to be displayed during dancing is determined (S1305). Then, if the evaluation data are displayed during dancing, the evaluation data are output to the control part 2 (S1306). Upon receipt of the output, the control part 2 creates the evaluation data and outputs them to the display part 5 through the steps of S1206 to S1208.

If the input does not correspond to any of 10-a to 10-f, then the process skips to S1307. In addition, even if the input corresponds to any of 10-a to 10-f, in the case of no need for displaying the evaluation data during dancing, the process skips to the step S1307 as well; however, the evaluation data are stored in the RAM in the determination part 6.

Then, if history information input from the input receiving part is in accord with predetermined definition data (S1307), the determination part 6 determines whether or not the evaluation data are to be displayed during dancing (S1308). If the evaluation data are displayed during dancing, the evaluation data are output to the control part 2 (S1309).

If history information input from the input receiving part is not in accord with predetermined definition data, then the process skips to the step S1310. In addition, even if history information input from the input receiving part is in accord with predetermined definition data, in the case of no need for displaying the evaluation data during dancing, the step skips to the step S1310; however, the evaluation data are stored in the RAM in the determination part 6.

Upon completing a music number, the process proceeds to the step S1310 at which the determination part 6 creates evaluation data, based on the dance input and history information that are input from the input receiving part 4 and stored in a RAM (S1311). If the music number is not yet complete, the process returns back to the step S1303, from which the process is repeated to the step 1309 until the music number is complete.

The evaluation data created after the music number is complete are output to the control part 2 (S1312). After the control part 2 receives the evaluation data from the determination part 6 (S1312), it then creates comment data (S1313) and output display data created based on the evaluation and the comment data to the display part 6 (S1314).

FIG. 14 is a flow chart for comment creation process in the dance game machine 1. Specifically, it is the flow chart describing a comment procedure to be used for the implementation of this embodiment of the dance game by the determination part 6.

The process shown in FIG. 14 starts with the step S1401 for storing information, which was used for a player to select a character at the step S1201 in FIG. 12 and loaded by the control part 2 (S1203), in the RAM in the determination part as definition data.

Then, the determination part 6 checks using an input signal from the input receiving part 4 whether or not a dance input implemented by a player corresponds to any of the causes for generation of comments 11-a to 11-n described in FIG. 11 (S1402).

If the input corresponds to any of the causes for generation of 11-a to 11-n, whether or not corresponding evaluation data are to be displayed during dancing is determined (S1403) and comment data are created based on a content of the corresponding comment selected from a group of various comment types described in FIG. 11 (S1404).

Then, if the comment data are displayed during dancing, the comment data are output to the control part 2 (S1405). Upon receipt of it, the control part 2 creates the comment data and outputs them to the display part 5 through the steps of S1206 to S1208.

If not corresponding to any of the causes for generation, 11-a to 11-n, then the process skips to the step S1406 and the comment data are stored in the RAM in the determination part 6.

Then, in the case that history information input from the input receiving part 4 is in accord with predetermined definition data (S1406), the determination part 6 determines whether or not the comment data are to be displayed during dancing (S1407). If the comment data are displayed during dancing, corresponding evaluation data are output to the control part 2 (S1408).

Upon completing a music number, the process proceeds to the step S1409 at which the determination part 6 creates comment data based on both the history information input from the input receiving part 4 and the evaluation data created by the determination part 6 itself (S1410).

If the history information is not in accord with the definition data, the process skips to the step S1409. Even if the history information is in accord with the predetermined definition data, in the case of no need for displaying corresponding comment data during dancing, the step skips to the step S1409 as well; however, the comment data are stored in the RAM in the determination part 6.

Upon completing the music number, the process proceeds to the step S1410 at which the created comment data are outputs to the control part 2. Upon receipt of the comment data (S1413), the control part 2 outputs display data created based on the evaluation data and the comment data to the display part 5 (S1214).

If the music number is not yet complete, the process returns back to the step S1402, from which the process is repeated to the step S1409 until the music number is complete. Also at the step S1410, if there is no need for creating comment data, then the process directly terminates.

FIG. 15 is a diagram illustrating a configuration of the storage part 3. The storage part is a group of data bases connected to the above-described control part 2 or determination part 6. In addition, in this embodiment, the storage part 3 is comprised of a music database 1500, a screen database 1510, and an evaluation database 1520.

The control part 2 manages all of the information through a database management function part (not shown). In other words, each of the databases is addressed, whereby corresponding information can be stored and managed. The information stored in the databases is output to the display part 5 or speakers through information transceiver function part (not shown).

The music database 1500 is a database comprising music numbers to be played and corresponding step data, dance data and beat data, and may be comprised of a middle-level database group consisting of a step database 1501, a dance database 1502, and a beat database 1503.

Specifically, the middle-level database group stores the following information: predefined step data for dancing depending on a music number to be played and the like are stored in the step database 1501.

The display database 1510 is a database comprising dancer data, comment data, and stage data, and may be comprised of a middle-level database group consisting of a dancer database 1511, a comment database 1512, and a stage database 1513.

Specifically, the middle-level database group stores the following information: the comment database 1512 stores information on comment types and corresponding causes for generation as described in FIG. 11 as a lower-level database group consisting of a comment type database 1518 and a comment generation cause database 1519.

The evaluation database 1520 is a database comprising level selection data, analysis content data, and history information, and may be comprised of a middle-level database group consisting of a level selection database 1521, an analysis content database 1522, and a history information database 1523.

Specifically, the middle-level database group stores the following information: the analysis content database stores information on score display screens as described with FIG. 8 and analysis information to be used for evaluation as described in FIG. 10 as a lower-level database group consisting of an EFFORT database 1525, an ACCURACY database 1526, a STYLE database 1527, and a SCORE database 1528.

The whole or a part of a program required for operating the above-described database groups for a dance game may be distributed in the form of a recording medium (a ROM, a flexible disc, a hard disc, a CD-ROM, an MO, a CD-R, or a flash memory) or the like onto (or into) which the whole or a part of the program is recorded.

In other words, a program for detecting data input through the dance pad in response to a music number reproduced by the reproducing apparatus and for implementing a procedure with which an determination part creates evaluation data, by using a computer provided to a dance game machine comprising: the reproducing apparatus for reproducing predetermined music numbers; the dance pad for inputting a player's dance motion; a display part for receiving image information corresponding to the predetermined music numbers; and a control part for creating evaluation data and comment data for the player's dance motion, may be distribute in the form of a computer-readable recording medium onto which the program is recorded.

The program recorded onto the recording medium comprises the steps of: in the case of that a mode in which instruction information to guide a dance motion in advance is not displayed is selected, predefining a motion for a predetermined part in a music number to be reproduced by the reproducing apparatus, and then in the case that operational input data based on a player's dance motion are in accord with the predefined data, creating data for good evaluation; creating predetermined comment data; and creating image data corresponding to the comment data and then outputting the image data to the display part.

All of the functions described herein are programmed to be implementable with the recording medium onto which the program configured in such a way is recorded, whereby a dance game having freestyle and interactive evaluation functions as a more exciting play mode can be realized.

FIG. 16 is a diagram illustrating an exterior configuration of a home-use dance game comprising the dance game machine 1. The home-use dance game machine 1 is comprised of dance pads 160, a television set 161 and a home-use game unit 162. In this embodiment, two dance pads 160 are connected to the input receiving part 4, whereby two players can simultaneously compete for a dance play with each other. In addition, further increasing the number of the dance pad 160 enables the increase in the number of participant players.

The television set 161 is a television set with video input terminals, available in the market. The home-use game unit 162 is a home use game unit having a built-in CD or DVD drive. The above-described control part 2, storage part 3, input receiving part 4, display part 5 and determination part 6 are, not exclusively, provided in the home-use game unit 162, and reproducing a DVD onto which the dance game program is recorded allows the dance game to start.

FIG. 17 is a diagram illustrating an exterior configuration of a dance game for business use comprising the dance game machine 1. The dance game for business use 1 is comprised of dance pads 170, a display 171, a game unit for business use 172, and speakers 173.

In this embodiment, two dance pads 170 are connected to the input receiving part 4, whereby two players can simultaneously compete for a dance play with each other. In addition, further increasing the number of the dance pad 170 enables the increase in the number of participant players. The display 171 is implemented within the dance game machine 1 and is comprised of a cathode-ray tube, a liquid crystal display device, or the like.

The game unit for business use 172 is a box in which the above-described control part 2, storage part 3, input receiving part 4, display part 5, and determination part 6, and the dance game program is stored in the storage part 3. The speakers 173 are implemented within the dance game machine 1 and fluorescent tubes with various colors are arranged around the speakers and configured to light in response to player's dance motions.

In this embodiment, an exemplary score display is described using FIG. 8; however, magnified individuals' scores may only be displayed instead of using such a display style as in FIG. 8 in consideration of the intent of the disclosed principles. Also, the storage part 3 may be configured to have multiple sets of data on displaying scores, from which a player may select data him-/herself. Furthermore, embodiments according to the disclosed principles comprise the determination part 6; but, not limited to this, the control part 2 may comprise the function of the determination part 6.

While various embodiments of the disclosed principles have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A dance game machine comprising a storage part, a control part, an input receiving part, a display part, and a determination part, the dance game machine having a mode in which instruction information to guide a human player's physical dance motion is output to the display part and a free dance mode in which the instruction information is not output to the display part at any time, wherein in the case that the mode in which the instruction information to guide a human player's physical dance motion is not output to the display part is selected,
the storage part stores music data and screen data corresponding to the mode;
the control part reproduces the stored music data sequentially as well as outputting screen data corresponding to the music data but excepting the instruction information to guide a human player's physical dance motion, to the display part;
the input receiving part receives operational input data based on a human player's physical dance motion while the music data are sequentially reproduced; and
the determination part determines based on the human player's physical dance motion that the player is matching the music data based on a number of inputs implemented at a critical timing during the reproduction of the music data.

2. The dance game machine according to claim 1, wherein the determination part analyzes the content of the music data to detect the critical timing.

3. A method for evaluating a dance of a player in a dance game having a free dance mode in which instruction information to guide a dance motion in advance is not displayed at any time, the method comprising:
reproducing predetermined music data;
receiving, through an operation input device connected to a computer, operational input data based on a human player's physical dance motion performed while the music data are reproduced;
outputting image information corresponding to the predetermined music data; and
evaluating the human player's physical dance motion based on the operational input, wherein in the case that the free dance mode is selected, the step of evaluating the human player's physical dance motion comprises determining that the player is matching the music data based on a number of inputs implemented at a critical timing during the reproduction of the music data.

4. The method according to claim 3, wherein the step of evaluating further comprises, before the step of determining, a step of analyzing the content of the music data to detect the critical timing.

5. A computer-readable recording medium onto which a program to be executed by a computer for implementing a dance game machine is recorded, wherein the dance game machine has a first mode in which instruction information to guide a human player's physical dance motion is output to a display part and a second mode in which the instruction information is not output to the display part at any time, the program causing the computer to execute steps of:
reproducing predetermined music data;
receiving, through an operation input device connected to the computer, operational input data based on a human player's physical dance motion performed while the music data are reproduced;
outputting image information corresponding to the predetermined music data; and
evaluating the human player's physical dance motion based on the operational input, wherein in the case that the second mode is selected, the step of evaluating the human player's physical dance motion comprises determining that the player is matching the music data based on a number of inputs implemented at a critical timing during the reproduction of the music data.

6. The computer-readable medium according to claim 5, wherein the step of evaluating further comprises, before the step of determining, a step of analyzing the content of the music data to detect the critical timing.
